(19) United States
(12) Patent Application Publication
(10) Pub. No.: US 2025/0113143 A1
(43) Pub. Date: Apr. 3, 2025

(54) IDENTIFICATION AND CONTINUOUS TRACKING OF AN ACOUSTIC SOURCE

(71) Applicant: Shure Acquisition Holdings, Inc., Niles, IL (US)

(72) Inventors: Bijal Joshi, Niles, IL (US); Ken Platz, Niles, IL (US); Guillaume Lamy, Chicago, IL (US)

(21) Appl. No.: 18/899,632

(22) Filed: Sep. 27, 2024

Related U.S. Application Data
(60) Provisional application No. 63/586,779, filed on Sep. 29, 2023.

(51) Int. Cl. H04R 1/40; G10L 17/20; H04R 1/08

(52) U.S. Cl. CPC H04R 1/406; G10L 17/20; H04R 1/08; H04R 2430/25

(57) ABSTRACT

Embodiments disclosed herein are configured to provide automatic identification and continuous tracking of an acoustic source generating audio signals in an acoustic environment. Embodiments can receive audio signals captured by steerable microphone arrays situated within the acoustic environment and identify, based on the audio signals and an acoustic source identification model, the acoustic source associated with the audio signals. Embodiments can generate, based on the audio signals, a localization object associated with the acoustic source and direct, based on the localization object, microphone lobes associated with the steerable microphone arrays toward the acoustic source. Embodiments can also generate, based on receiving subsequent audio signals, an updated localization object associated with the acoustic source and direct, based on the updated localization object, the microphone lobes of the steerable microphone arrays toward the acoustic source.

### CROSS-REFERENCE TO RELATED APPLICATIONS

The present application claims priority to U.S. Provisional Application Ser. No. 63/586,779, titled “IDENTIFICATION AND CONTINUOUS TRACKING OF AN ACOUSTIC SOURCE,” filed Sep. 29, 2023, the entire contents of which are incorporated herein by reference.

### TECHNICAL FIELD

Embodiments of the present disclosure relate generally to audio processing and, more particularly, to applying machine learning models to identify and continuously track an acoustic source generating audio signals in an acoustic environment.

### BACKGROUND

Audio capture devices can be employed to capture audio signals generated by one or more acoustic sources in an acoustic environment. However, as the one or more acoustic sources change position in the acoustic environment, the audio capture devices may not capture the audio signals sufficiently. This insufficient capture of the audio signals may result in poor quality processing and/or output of the audio signals.

### BRIEF SUMMARY

Various embodiments of the present disclosure are directed to apparatuses, systems, methods, and computer readable media configured for applying machine learning models to identify and continuously track an acoustic source generating audio signals in an acoustic environment. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1A illustrates an example acoustic source identification and tracking system in accordance with one or more embodiments disclosed herein;

FIG. 1B illustrates another example acoustic source identification and tracking system in accordance with one or more embodiments disclosed herein;

FIG. 2 illustrates an example apparatus configured in accordance with one or more embodiments disclosed herein;

FIG. 3 illustrates an example dataflow diagram associated with an acoustic source identification model in accordance with one or more embodiments disclosed herein;

FIG. 4 illustrates example operations for identification and continuous tracking of an acoustic source in a respective acoustic environment in accordance with one or more embodiments disclosed herein;

FIG. 5 illustrates example operations for applying a personalized equalization (EQ) to one or more audio signals generated by a respective acoustic source in accordance with one or more embodiments disclosed herein;

FIG. 6 illustrates example operations for applying a personalized voice lift to one or more audio signals generated by a respective acoustic source in accordance with one or more embodiments disclosed herein; and

FIG. 7 illustrates example operations for applying a personalized microphone lobe priority to a specific acoustic source of a plurality of acoustic sources in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

One or more microphones can be employed to capture audio signals generated by an acoustic source (e.g., a human speaker) in a respective acoustic environment. However, in scenarios in which the acoustic source is continuously navigating the acoustic environment, conventional microphone systems may not be configured to adapt to the movements of the acoustic source such that the audio signals generated by the acoustic source may not be sufficiently captured and/or output to one or more respective listening entities (e.g., to members of a target audience). The problem presented in this first example scenario is compounded when the acoustic source changes position (e.g., location, orientation, directional heading, elevation, etc.) within the acoustic environment.

Furthermore, in a second example scenario in which there is a plurality of acoustic sources (e.g., one or more human speakers) and/or a plurality of extraneous noise sources (e.g., one or more audience members, one or more musical instruments, one or more mechanical devices, etc.) in the respective acoustic environment, conventional microphone systems may capture superfluous audio signals that interfere with the capture and/or output of desired audio signals generated by one or more acoustic sources of the plurality of acoustic sources. The problem presented in this second example scenario is compounded similarly to the first example scenario when one or more acoustic sources of the plurality of acoustic sources are navigating the acoustic environment and/or changing respective positions (e.g., respective locations, respective orientations, respective directional headings, respective elevations, etc.) while generating respective, potentially desired audio signals.

To address these and/or other technical problems associated with traditional microphone systems, various embodiments disclosed herein provide an acoustic source identification and tracking system configured for identifying and continuously tracking one or more acoustic sources generating audio signals as the one or more acoustic sources navigate a respective acoustic environment. Embodiments described herein offer a multitude of technical benefits over traditional microphone systems by employing improved techniques including one or more steerable microphone arrays configured to execute one or more beamforming and/or localization techniques to locate an acoustic source within an acoustic environment, track the acoustic source as the acoustic source navigates the acoustic environment, and direct one or more respective microphone lobes toward the acoustic source to better capture one or more audio signals generated by the acoustic source.

Embodiments herein also provide improved technical solutions over traditional microphone systems by applying machine learning models such as, for example, an acoustic source identification model, to identify a particular acoustic source (e.g., a particular human speaker, a particular musical instrument, etc.) and continuously track the identified acoustic source (e.g., as part of the steerable microphone array handoff) as the identified acoustic source navigates a respective acoustic environment. The machine learning models may also provide one or more derived applications from the combination of acoustic source identification and continuous acoustic source tracking.

### Example Systems and Apparatuses for Acoustic Source Identification and Tracking

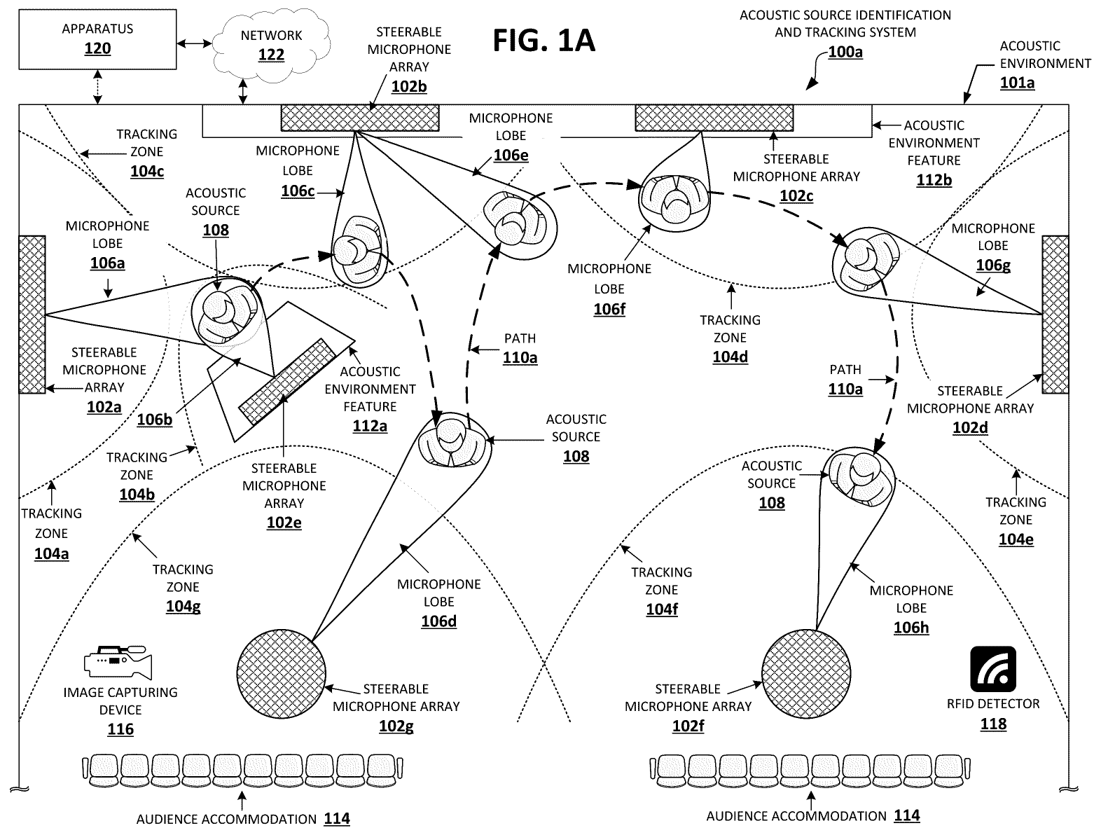

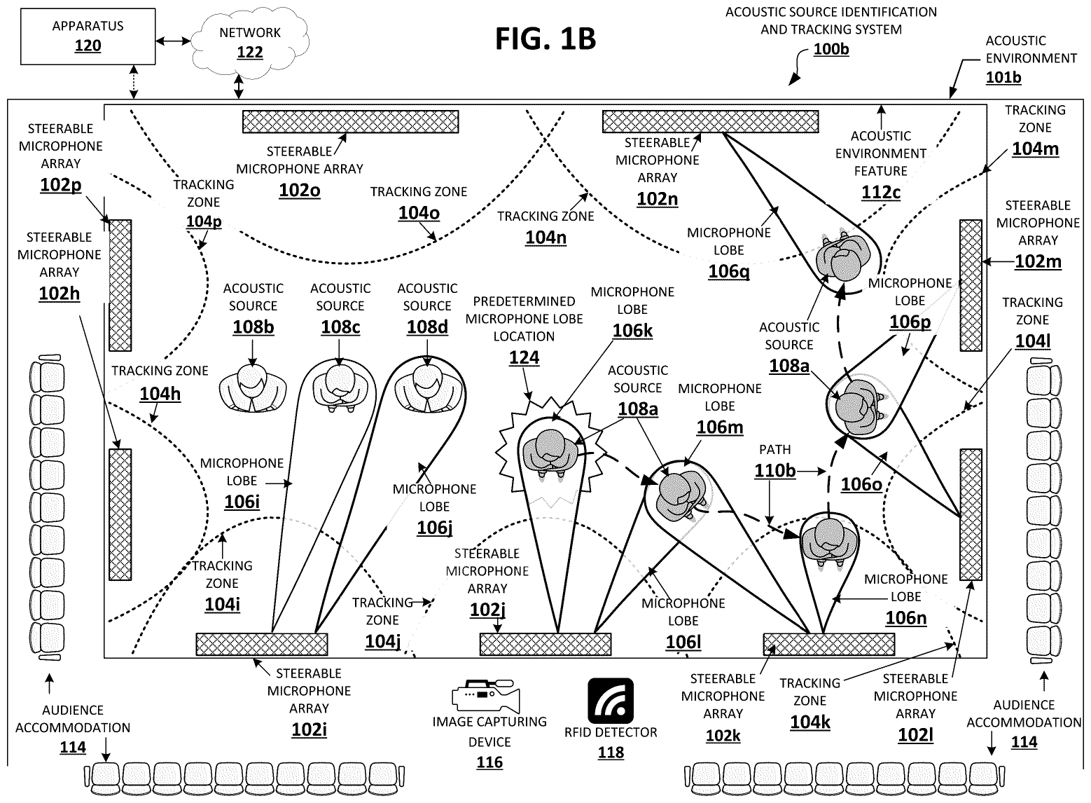

FIG. 1A illustrates an example acoustic source identification and tracking system 100a in accordance with one or more embodiments disclosed herein. Specifically, FIG. 1A illustrates an example acoustic source identification and tracking system 100a that is configured to provide the identification and continuous tracking of a single acoustic source generating audio signals in an acoustic environment 101a. The acoustic source identification and tracking system 100a associated with the acoustic environment 101a may include one or more steerable microphone arrays 102a-n, one or more tracking zones 104a-n associated with the one or more steerable microphone arrays 102a-n, one or more microphone lobes 106a-n associated with the one or more steerable microphone arrays, an image capturing device 116, a radio frequency identification (RFID) detector 118, an apparatus 120, and/or a network 122. As shown, the acoustic environment 101a may comprise one or more acoustic environment features 112a-n, and/or audience accommodations 114 (e.g., chairs, desks, pews, stadium seating, and/or the like). Also shown in FIG. 1A is an example acoustic source 108 traversing a path 110a across the acoustic environment 101a.

In various examples, acoustic environment 101a may comprise and/or be embodied by, but is not limited to, a performance space (e.g., a theater space, concert venue, etc.), a lecture hall, an arena, a sporting venue, a room (e.g., a conference room), an event space (e.g., an indoor or outdoor event space), and/or the like. One or more steerable microphone arrays 102a-n can be positioned in predetermined locations associated with the acoustic environment.

In various examples, one or more steerable microphone arrays 102a-n associated with an acoustic source identification and tracking system 100a may be configured to dynamically generate and direct one or more microphone lobes 106a-n (also referred to herein as beams) associated with a polar pattern (also referred to herein as a pickup pattern) of a respective steerable microphone array 102a. The polar pattern of a steerable microphone array 102a can generally be understood as a directionality of the steerable microphone array 102a, and more specifically as a defined signal attenuation at a given angular direction from the steerable microphone array 102a relative to a central axis of the steerable microphone array 102a. As such, the one or more microphone lobes 106a-n associated with the polar pattern of a respective steerable microphone array 102a can be shaped and/or controlled via digital signal processing (DSP) such that the one or more microphone lobes 106a-n may be directed toward (e.g., aimed) at a particular acoustic source 108 as the particular acoustic source 108 generates one or more audio signals while navigating the acoustic environment 101a, thus ensuring improved capture and output of the one or more audio signals.

In some examples, one or more steerable microphone arrays 102a-n may be configured to be mounted on, installed in, coupled to, embodied by, attached to, integrated with, positioned proximate to, and/or otherwise be associated with a respective acoustic environment feature 112. Examples of an acoustic environment feature 112 include a whiteboard, a podium, a wall, a ceiling, a set-piece, and/or the like. As shown in FIG. 1A, steerable microphone array 102e is installed in the acoustic environment feature 112a that is configured as a podium. Also shown in FIG. 1A, steerable microphone arrays 102b and 102c are associated with coupled to the acoustic environment feature 112b that is configured as a whiteboard. One or more steerable microphone arrays 102a-n may be installed in one or more respective walls associated with the acoustic environment such as, for example, steerable microphone arrays 102a and 102d. Additionally or alternatively, one or more steerable microphone arrays 102a-n may be installed in a ceiling associated with the acoustic environment 101a such as, for example, steerable microphone arrays 102g and 102f.

One or more steerable microphone arrays 102a-n may be associated with one or more respective tracking zones 104a-n associated with acoustic environment 101a. A particular tracking zone (e.g., tracking zone 104g) may be associated with a predetermined audio capture coverage area of a respective steerable microphone array (e.g., steerable microphone array 102g). In various embodiments, the predetermined audio capture coverage area of the respective steerable microphone array (e.g., steerable microphone array 102g) can be associated with an aggregation of the polar patterns associated with the plurality of microphones comprised within the respective steerable microphone array (e.g., steerable microphone array 102g).

In some examples, an apparatus 120 associated with an acoustic source identification and tracking system 100a may be configured to define, adjust, augment, update, and/or otherwise manage one or more tracking zones 104a-n and/or one or more audio capture coverage areas associated with one or more respective steerable microphone arrays 102a-n. For example, the apparatus 120 may employ one or more DSP techniques to define a tracking zone (e.g., tracking zone 104b) related to a predetermined audio coverage area associated with a respective steerable microphone array (e.g., steerable microphone array 102e associated with the acoustic environment feature 112a) in a respective acoustic environment 101a. In this regard, the general shape of the one or more tracking zones 104a-n and/or the one or more audio capture coverage areas associated with one or more respective steerable microphone arrays 102a-n may be selectable via the apparatus 120.

In various examples, the apparatus 120 can generate and/or direct one or more microphone lobes 106a-n toward an acoustic source 108 generating audio signals based on an orientation of the acoustic source 108 relative to a tracking zone (e.g., tracking zone 104b) associated with a respective steerable microphone array (e.g., the steerable microphone array 102e associated with the acoustic environment feature 112a) in the acoustic environment 101a. In some examples, the one or more microphone lobes 106a-n may “reach” (e.g., be directed toward) an acoustic source 108 that is located within or outside of a respective tracking zone (e.g., tracking zone 104bc). In scenarios in which the acoustic source 108 is moving beyond the bounds of the respective tracking zone, the apparatus 120 can still generate and/or direct one or more microphone lobes 106a-n toward the acoustic source 108. However, the one or more audio signals generated by the acoustic source 108 as the acoustic source 108 moves away from the respective tracking zone may be captured a lower level relative to other audio signals generated in a closer proximity to the steerable microphone array associated with the tracking zone.

In such examples, the acoustic source identification and tracking system 100a is configured to cause a microphone array handoff in order to ensure the continuous capture of audio signals and continuous tracking of the location of acoustic source 108 traversing acoustic environment 101a. To facilitate the steerable microphone array handoff, apparatus 120 may be configured to generate a localization object associated with the acoustic source 108 based on the audio signals generated by the acoustic source 108.

In various examples, the localization object may comprise one or more portions of positional data related to the identified acoustic source 108 within the acoustic environment 101a. For example, the localization object may comprise one or more coordinates such as latitude, longitude, range, and/or altitude coordinates associated with the acoustic source 108. In some embodiments, the localization object may comprise one or more coordinates associated with an x-, y-axis of a two-dimensional coordinate plane associated with the acoustic environment 101a. Additionally or alternatively, in some embodiments, the localization object may comprise one or more coordinates associated with an x-, y-, and/or z-axis of a three-dimensional coordinate plane associated with the acoustic environment 101a. Additionally or alternatively, in some embodiments, the localization object may comprise data related to a position of the acoustic source 108 relative to one or more tracking zones 104a-n associated with one or more steerable microphone arrays 102a-n situated in the acoustic environment 101a. As such, the apparatus 120 may be configured to direct a first microphone lobe (e.g., microphone lobe 106c) of a first steerable microphone array (e.g., steerable microphone array 102b) toward an acoustic source (e.g., acoustic source 108) based on the localization object associated with the acoustic source 108.

Additionally or alternatively, the apparatus 120 may be configured to direct the first microphone lobe (e.g., the microphone lobe 106c) of the first steerable microphone array (e.g., the steerable microphone array 102b) toward the acoustic source 108 based on a first plurality of audio signal attributes and/or one or more audio signal attribute values related to the first plurality of audio signal attributes associated with a first plurality of audio signals generated by the acoustic source 108 within range of a first tracking zone (e.g., tracking zone 104c) associated with the first steerable microphone array (e.g., the steerable microphone array 102b).

The apparatus 120 may also be configured to determine that the acoustic source 108 is navigating toward a second tracking zone (e.g., tracking zone 104g) associated with a second steerable microphone array (e.g., steerable microphone array 102g). In some examples, the apparatus 120 can determine that the acoustic source 108 is navigating toward a second tracking zone (e.g., tracking zone 104g) associated with a second steerable microphone array (e.g., steerable microphone array 102g) based on one or more audio signals generated subsequently to the first plurality of audio signals generated by the acoustic source.

As such, the apparatus 120 can generate an updated localization object associated with the acoustic source 108 based on the subsequently generated audio signals. In various embodiments, the apparatus 120 may be configured to direct a second microphone lobe (e.g., microphone lobe 106d) of the second steerable microphone array (e.g., steerable microphone array 102g) toward the acoustic source 108 based on the updated localization object. Additionally or alternatively, the apparatus 120 may be configured to direct the second microphone lobe (e.g., the microphone lobe 106d) of the second steerable microphone array (e.g., steerable microphone array 102g) toward the acoustic source 108 based on a second plurality of audio signal attributes associated with a second plurality of audio signals generated by the acoustic source 108 within range of the second tracking zone (e.g., tracking zone 104g) associated with the second steerable microphone array (e.g., the steerable microphone array 102g). In this manner, the apparatus 120 can ensure the continuous location tracking of the acoustic source 108 as well as the capture and/or output of one or more desired audio signals being generated by the acoustic source 108 as the acoustic source 108 traverses the acoustic environment 101a.

In some examples, the apparatus 120 may be configured to direct two or more microphone lobes from two or more respective steerable microphone arrays towards a particular acoustic source that is generating audio signals proximate to the tracking zones of the two or more respective steerable microphone arrays. For example, as illustrated in FIG. 1A, the apparatus 120 may direct a first microphone lobe (e.g., microphone lobe 106a) from a first steerable microphone array (e.g., steerable microphone array 102a) towards an acoustic source 108, and simultaneously direct a second microphone lobe (e.g., microphone lobe 106b) from a second steerable microphone array (e.g., steerable microphone array 102e) towards the acoustic source 108 while the acoustic source is generating audio signals proximate to the tracking zones of the two or more respective steerable microphone arrays (e.g., tracking zones 104a and 104b associated with steerable microphone arrays 102a and 102e respectively).

In various examples, the apparatus 120 may be configured to determine a preferred microphone lobe of the two or more microphone lobes 106a-n based on one or more of a position (e.g., location, orientation, directional heading, etc.) of the acoustic source 108, one or more audio signal attribute values associated with the respective audio signals being generated by the acoustic source, and/or a predetermined steerable microphone array priority associated with the two or more respective steerable microphone arrays 102a-n. As such, in various examples, the apparatus 120 may be configured to cause output of the respective audio signals being generated by the acoustic source 108 based on the preferred microphone lobe of the two or more microphone lobes 106a-n.

In some examples, the apparatus 120 may be configured to employ an acoustic source identification model to facilitate one or more of the methods described herein. The acoustic source identification model may comprise, employ, direct, and/or otherwise integrate with one or more artificial intelligence (AI) models trained to perform one or more AI techniques and/or one or more machine learning (ML) techniques for identifying an acoustic source 108 that is generating audio signals in a respective acoustic environment 101a and/or for continuously tracking the acoustic source 108 as the acoustic source 108 navigates the respective acoustic environment 101a.

In various examples, one or more image capturing devices 116 may be installed, mounted, positioned, and/or otherwise associated with acoustic environment 101a. An image capturing device 116 may be a device configured to capture one or more portions of image data, including image data related to an acoustic source 108. An image capturing device 116 may include a camera (e.g., a video camera, a pan-tilt-zoom (PTZ) camera, a photographic camera, a LIDAR camera, an infrared camera, a thermal camera, or any other device capable of imaging an acoustic source and/or an acoustic environment associated with the acoustic source for one or more of the respective functions described herein). In various examples, the image capturing device 116 can capture one or more types of image data including videos, still photos, bursts photos, and/or the like that can be directly or indirectly employed to identify an acoustic source 108. The image data can be associated with a respective user audio profile associated with the respective acoustic source. Furthermore, in one or more embodiments, the image data may be used to train, re-train, and/or update one or more models (e.g., a facial recognition model) associated with the acoustic source identification model.

In various examples, the apparatus 120 may also be configured to identify a human speaker based on detecting a radio frequency identification (RFID) tag by one or more RFID detectors 118 situated in the acoustic environment 101a, where the RFID tag is associated with a user audio profile associated with the human speaker. For example, one or more human speakers may be associated with (e.g., carrying) a respective RFID tag (e.g., an RFID chip embedded in an identification badge associated with a respective organization) as the one or more human speakers are traversing the acoustic environment. As such, the apparatus 120 may be configured to determine a user audio profile associated with the one or more human speakers based on one or more portions of data associated with the respective RFID tags that are decoded by the RFID detector 118 as the human speakers navigate the acoustic environment.

In various examples, the one or more RFID detectors 118 may be installed, mounted, positioned, and/or otherwise associated with a respective acoustic environment 101a-b. An RFID detector 118 may be a device configured to detect, monitor, and/or track one or more RFID tags associated with one or more respective acoustic sources as the one or more respective acoustic sources traverse a respective acoustic environment. Furthermore, an RFID detector 118 may be configured to decode, read, parse, analyze, transmit, and/or otherwise manage one or more portions of data (e.g., user identification data) associated with a detected RFID tag.

For example, in various embodiments, an RFID tag related to a respective acoustic source (e.g., a human speaker) may be linked to a respective user audio profile associated with the acoustic source. As such, the RFID detector 118 may transmit one or more portions of data (e.g., user identification data) to the apparatus 120 such that the apparatus 120 may determine the respective user audio profile associated with the acoustic source. In this manner, the RFID detector 118 can be employed to facilitate the identification of an acoustic source and therefore facilitate one or more of the methods described herein (e.g., enable the application of a personalized EQ to one or more audios signals associated with the identified acoustic source).

In various examples, the network 122 is any suitable network or combination of networks and supports any appropriate protocol suitable for communication of data to and from one or more computing devices. According to various embodiments, network 122 includes a public network (e.g., the Internet), a private network (e.g., a network within an organization), or a combination of public and/or private networks. According to various embodiments, network 122 is configured to provide communication between various components of an acoustic source identification and tracking system (e.g., one or more steerable microphone arrays 102a-n, image capturing devices 116, RFID detectors 118, and/or the apparatus 120).

According to various examples, the network 122 comprises one or more networks that connect devices and/or components in the network layout to allow communication between the devices and/or components. For example, in one or more embodiments, the network 122 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, the network 122 is implemented using cellular networks, satellite, licensed radio, or a combination of cellular, satellite, licensed radio, and/or unlicensed radio networks.

FIG. 1B illustrates an example acoustic source identification and tracking system 100b in accordance with one or more embodiments disclosed herein. Specifically, FIG. 1B illustrates that the example acoustic source identification and tracking system 100b may be configured to provide the identification and continuous tracking of a plurality of acoustic sources 108a-n generating audio signals in an acoustic environment 101b. The acoustic source identification and tracking system 100b may include one or more steerable microphone arrays 102a-n, one or more tracking zones 104a-n associated with the one or more steerable microphone arrays 102a-n, one or more microphone lobes 106a-n associated with the one or more steerable microphone arrays, a predetermined microphone lobe location 124, an image capturing device 116, an RFID detector 118, an apparatus 120, and/or a network 122. As shown, the acoustic environment 101b may comprise an acoustic environment feature 112c configured as a stage, and/or audience accommodations 114 (e.g., chairs, desks, pews, stadium seating, and/or the like). Also shown in FIG. 1B is a plurality of acoustic sources 108a-d and, as illustrated, the acoustic source 108a is depicted traversing a path 110b across the acoustic environment 101b.

In some examples, an acoustic source identification model may be configured to identify that a particular acoustic source 108a is a first acoustic source of a plurality of acoustic sources 108a-108n generating respective audio signals within acoustic environment 101b. For example, the first acoustic source may be a first human speaker of a plurality of human speakers generating respective audio signals in the acoustic environment.

The acoustic source identification model may determine (e.g., using apparatus 120) that the one or more steerable microphone arrays 102a-n are capturing audio signals from one or more distinct acoustic sources 108a-d (e.g., one or more human speakers). In various embodiments, the apparatus 120 may be configured to generate a localization object for the one or more respective, distinct acoustic sources 108a-d (e.g., the one or more human speakers). As such, the apparatus 120 may cause one or more steerable microphone arrays (e.g., steerable microphone arrays 102i, and/or 102j) to direct one or more respective microphone lobes toward the one or more distinct acoustic sources based on the localization objects associated with the one or more respective, distinct acoustic sources. The apparatus 120, in conjunction with an acoustic source identification model may be configured to simultaneously identify each acoustic source of the plurality of acoustic sources 108a-d based on one or more audio signals generated by the plurality of acoustic sources.

Furthermore, as illustrated in FIG. 1B, in various examples, the acoustic source identification model may apply (e.g., by using the apparatus 120) a personalized microphone lobe priority to acoustic source 108a of the one or more acoustic sources 108a-d generating audio signals in an acoustic environment. In various examples, the personalized microphone lobe priority is configured to facilitate the prioritization of the one or more audio signals generated by the acoustic source 108a relative to the other acoustic sources 108b-d. In various examples, the acoustic source 108a may be a primary acoustic source of the acoustic sources 108a-d. In some examples, the acoustic source identification model may automatically apply (e.g., by using the apparatus 120) the personalized microphone lobe priority to the primary acoustic source upon identification of the primary acoustic source.

In various examples, the acoustic source identification model may generate and/or apply (e.g., by using the apparatus 120) the personalized microphone lobe priority to the primary acoustic source based on at least one of one or more portions of user audio profile data retrieved after the identification of the specific acoustic source, a ranking associated with the specific acoustic source, a priority level associated with the specific acoustic source, a priority list associated with the one or more acoustic sources, a detected RFID tag associated with the specific acoustic source, one or more portions of mixture model output generated based on one or more portions of voice feature data associated with the first acoustic source, and/or one or more portions of image data associated with the specific acoustic source.

In some examples, the personalized microphone lobe priority may be associated with a respective microphone lobe that is currently directed toward the acoustic source 108a as the specific acoustic source moves through the acoustic environment 101b. For example, as shown in FIG. 1B, if the acoustic source identification model has applied a personalized microphone lobe priority to the acoustic source 108a and the acoustic source 108a begins to traverse the acoustic environment 101b, the personalized microphone lobe priority will be associated with each subsequent microphone lobe (e.g., microphone lobes 1061-106q) directed toward the acoustic source 108a as the acoustic source 108a traverses the acoustic environment 101b. For example, the personalized microphone lobe priority may be associated first with the microphone lobe 1061 associated with the steerable microphone array 102j and then subsequently associated with the microphone lobe 106m associated with the steerable microphone array 102k as the acoustic source 108a navigates toward tracking zone 104k while generating audio signals.

Additionally or alternatively, in various examples, the acoustic source identification model may apply (e.g., by using the apparatus 120) a personalized microphone lobe priority to a predetermined microphone lobe location 124 associated with the acoustic environment 101b. As described herein, a predetermined microphone lobe location 124 may be a location associated with the acoustic environment 101b (e.g., a particular chair, a particular set-piece, a centerstage location, and/or the like). Additionally or alternatively, in various examples, the personalized microphone lobe priority may be associated with a tracking zone (e.g., tracking zone 104j) of a respective steerable microphone array (e.g., steerable microphone array 102j).

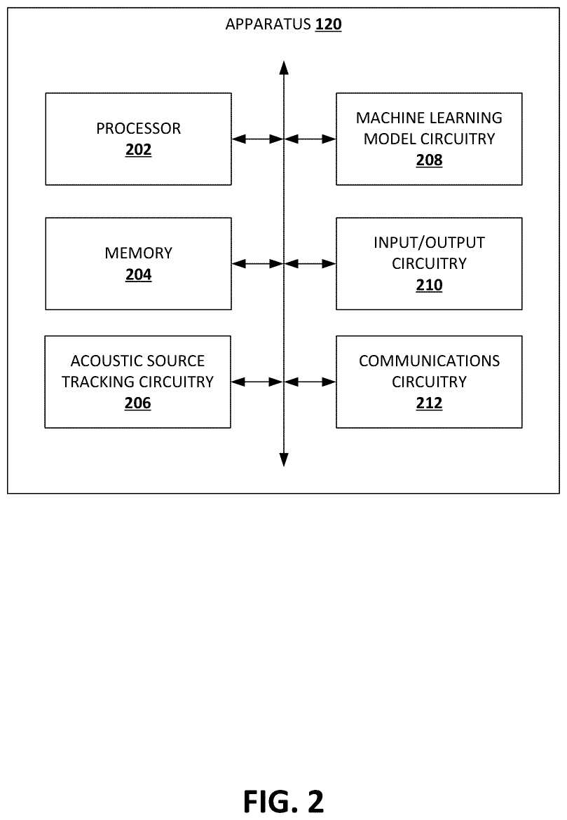

FIG. 2 illustrates an example apparatus 120 configured in accordance with one or more embodiments of the disclosed herein. The apparatus 120 may be configured to perform one or more techniques detailed in the descriptions of FIG. 1A, FIG. 1B, and/or one or more other techniques described herein. In some examples, the apparatus 120 may be a computing system communicatively coupled with, and configured to control, one or more circuit modules associated with acoustic source identification, acoustic source tracking, audio signal processing, steerable microphone array management, machine learning model implementation, and/or network communications. The apparatus 120 may comprise and/or otherwise be in communication with a processor 202, a memory 204, acoustic source tracking circuitry 206, machine learning model circuitry 208, input/output circuitry 210, and/or communications circuitry 212.

In some examples, the processor 202 (which may comprise multiple or co-processors or any other processing circuitry associated with the processor) may be in communication with the memory 204. In one or more embodiments, the apparatus 120 may be configured as a computing device comprising one or more processors, non-transitory memories, and/or communications circuitries configured to control, manipulate, direct, interface with, and/or facilitate the transmission and/or reception of one or more portions of data (e.g., audio signals, user audio profile data, and/or the like) between the one or more components of a respective acoustic source identification and tracking system 100a-b.

In various examples, the apparatus 120 and/or the one or more components of the acoustic source identification and tracking system can be configured to communicate via the network 122. Additionally or alternatively, the apparatus 120 and/or the one or more components of the acoustic source identification and tracking system can be configured to communicate via one or more hardwired connections, busses, switches, signal processors, mixers, and/or other physical communications media and/or equipment. In one or more embodiments, the apparatus 120 may be configured to execute, and/or facilitate the execution of, the one or more processes, methods, techniques, instructions, and/or commands associated with the acoustic source identification model associated with the acoustic source identification and tracking system.

In some examples, the processor 202 may be embodied in a number of different ways. For example, the processor 202 may be embodied as one or more of various hardware processing means such as a central processing unit (CPU), a microprocessor, a coprocessor, a DSP, an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 202 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 202 may comprise one or more processing cores configured to perform independently. A multi-core processor may enable multiprocessing within a single physical package. Additionally or alternatively, the processor 202 may comprise one or more processors configured in tandem via the bus to enable execution of instructions, pipelining, and/or multithreading.

In some examples, the processor 202 may be configured to execute instructions, such as computer program code or instructions, stored in the memory 204 or otherwise accessible to the processor 202. Alternatively or additionally, the processor 202 may be configured to execute hard-coded functionality. As such, whether configured by hardware or software instructions, or by a combination thereof, the processor 202 may represent a computing entity (e.g., physically embodied in circuitry) configured to perform operations according to an embodiment of the present disclosure described herein. For example, when the processor 202 is embodied as an CPU, DSP, ARM, FPGA, ASIC, or similar, the processor may be configured as hardware for conducting the operations of an embodiment of the disclosure.

Alternatively, when the processor 202 is embodied to execute software or computer program instructions, the instructions may specifically configure the processor 202 to perform the algorithms and/or operations described herein when the instructions are executed. However, in some examples, the processor 202 may be a processor of a device specifically configured to employ an embodiment of the present disclosure by further configuration of the processor using instructions for performing the algorithms and/or operations described herein. The processor 202 may further comprise a clock, an arithmetic logic unit (ALU) and logic gates configured to support operation of the processor 202, among other things.

The memory 204 may comprise non-transitory memory circuitry and may comprise one or more volatile and/or non-volatile memories. In some examples, the memory 204 may be an electronic storage device (e.g., a computer readable storage medium) configured to store data that may be retrievable by the processor 202. In some examples, the data stored in the memory 204 may comprise radio frequency signal data, audio signal data, stereo audio signal data, mono audio signal data, steerable microphone array data, image data, machine learning model configuration data, machine learning model training data, acoustic environment data, and/or the like for enabling the apparatus 120 to carry out various functions or methods in accordance with embodiments of the present disclosure described herein.

In one or more examples, the apparatus 120 may comprise the acoustic source tracking circuitry 206. The acoustic source tracking circuitry 206 may be any means embodied in either hardware or a combination of hardware and software that is configured to perform one or more functions disclosed herein related to the locating, tracking, RFID detection, and/or monitoring of one or more acoustic sources 108 traversing a respective acoustic environment 101a-b.

In various examples, the acoustic source tracking circuitry 206 is configured to cause the generation of one or more localization objects associated with one or more respective acoustic sources. Furthermore, the acoustic source tracking circuitry 206 is configured to update, delete, and/or otherwise manage the one or more localization objects. For example, the acoustic source tracking circuitry 206 is configured to generate updated localization objects associated with one or more respective acoustic sources as the one or more respective acoustic sources traverse the acoustic environment. In some examples, the acoustic source tracking circuitry 206 may work in conjunction with the image capturing device 116 to track one or more acoustic sources. The acoustic source tracking circuitry 206 may also work in conjunction with the RFID detector 118 to track and/or identify an acoustic source.

Furthermore, in various examples, the acoustic source tracking circuitry 206 may be any means embodied in either hardware or a combination of hardware and software that is configured to perform one or more functions disclosed herein related to causing a steerable microphone array (e.g., steerable microphone array 102e) to direct a respective microphone lobe (e.g., microphone lobe 106b) toward a particular acoustic source (e.g., acoustic source 108). In various examples the acoustic source tracking circuitry 206 may work in conjunction with the machine learning model circuitry 208 to identify one or more acoustic sources generating audio signals in a respective acoustic environment.

In one or more examples, the apparatus 120 may comprise the machine learning model circuitry 208. The machine learning model circuitry 208 may be any means embodied in either hardware or a combination of hardware and software that is configured to perform one or more functions disclosed herein related to the acoustic source identification model and/or any of the one or more models comprised in and/or integrated with the acoustic source identification model. Additionally, the machine learning model circuitry 208 is configured to train, re-train, update, configure, and/or otherwise manage the acoustic source identification model and/or any of the one or more models comprised in and/or integrated with the acoustic source identification model. As such, the machine learning model circuitry 208 is configured to receive, transmit, and/or otherwise facilitate the communication of one or more portions of data related to the execution of the one or more methods and/or techniques associated with the acoustic source identification model and/or any of the one or more models comprised in and/or integrated with the acoustic source identification model.

In various examples, the apparatus 120 may comprise the input/output circuitry 210 that may, in turn, be in communication with processor 202 to provide output to the user and, in some examples, to receive an indication of a user input. For example, in some embodiments, the input/output circuitry 210 can integrate with the one or more steerable microphone arrays 102a-n. The input/output circuitry 210 may comprise a user interface and may comprise a display. In some examples, the input/output circuitry 210 may also comprise a keyboard, a touch screen, touch areas, soft keys, buttons, knobs, or other input/output mechanisms. The input/output circuitry 210 may also comprise or integrate with one or more speakers, array speakers, sound bars, headphones, earphones, in-ear monitors, and/or other listening devices capable of outputting one or more various audio signals (e.g., one or more audio signals associated with an acoustic source).

In one or more examples, the apparatus 120 may comprise the communications circuitry 212. The communications circuitry 212 may be any means embodied in either hardware or a combination of hardware and software that is configured to receive and/or transmit data from/to a network 122 and/or any other device or module in communication with the apparatus 120. In this regard, the communications circuitry 212 may comprise, for example, an antennae or one or more other communication devices for enabling communications with a wired or wireless communication network. For example, the communications circuitry 212 may comprise antennae, one or more network interface cards, buses, switches, routers, modems, and supporting hardware and/or software, or any other device suitable for enabling communications via a network. Additionally or alternatively, the communications circuitry 212 may comprise the circuitry for interacting with the antenna/antennae to cause transmission of signals via the antenna/antennae or to handle receipt of signals received via the antenna/antennae.

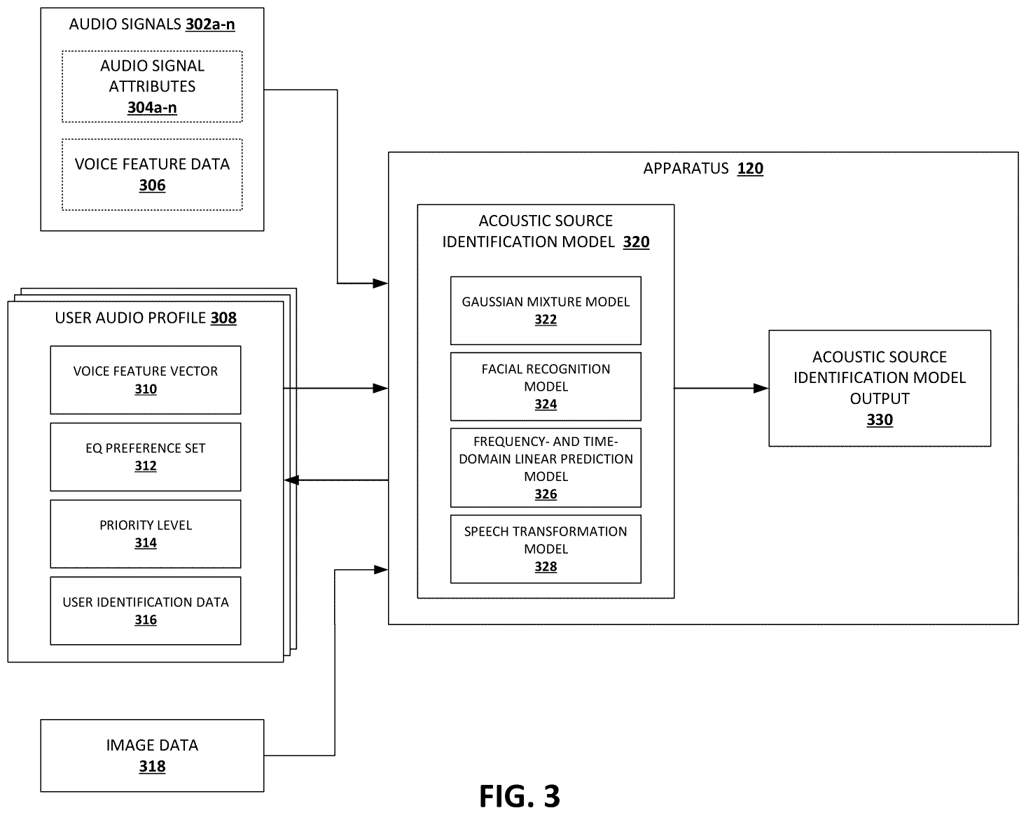

FIG. 3 illustrates an example dataflow diagram associated with an acoustic source identification model 320 in accordance with one or more embodiments disclosed herein. Specifically, FIG. 3 illustrates the flow of data associated with an acoustic source 108 that may be processed by an apparatus 120 comprising the acoustic source identification model 320. As shown, one or more portions of data related to one or more audio signals 302a-n, a user audio profile 308, and/or image data 318 associated with an acoustic source 108 can be processed by the apparatus 120 and/or input into the acoustic source identification model 320.

In various examples, the audio signals 302a-n may be associated with one or more audio signal attributes 304a-n and/or one or more portions of voice feature data 306. A particular user audio profile 308 associated with a respective acoustic source 108 may comprise one or more of a voice feature vector 310, an EQ preference set 312, a priority level 314, and/or one or more portions of user identification data 316 (e.g., user contact data, organizational hierarchy data, role data, image data, and/or the like). In various examples, the image data 318 may be captured by an image capturing device 116 associated with a respective acoustic environment 101a-b.

In some examples, the one or more audio signal attributes 304a-n may comprise one or more acoustic features comprising at least one of an angle of arrival, a gain, a frequency, a pitch, a timbre, an articulation, a volume, or an intensity. Additionally or alternatively, the one or more audio signal attributes 304a-n may also comprise one or more emotive qualities comprising at least one of a valence, an activation, or a dominance. Additionally or alternatively, the one or more audio signal attributes 304a-n may also comprise one or more speech delivery characteristics comprising at least one of a pause duration, a pace, or a speech rate. Furthermore, in various examples, the one or more audio signal attributes 304a-n may be associated with an audio signal attribute value related to, for example, a measurement value, a quality value, and/or the like. As an example, an audio signal attribute value associated with a respective audio signal attribute 304a may describe an amount of measured volume (e.g., in decibels) associated with the respective audio signal 302a.

The acoustic source identification model 320 can be configured to capture, encode, decode, regenerate, analyze, process, and/or otherwise manage one or more audio signals 302a-n generated by a respective acoustic source, and/or the acoustic source identification model 320 can be configured to execute any combination of capturing, encoding, decoding, regenerating, analyzing, processing, and/or managing of the one or more audio signals 302a-n. In certain embodiments, the acoustic source identification model 320 may comprise, employ, direct, and/or otherwise integrate with one or more artificial neural networks (ANNs), convolutional neural networks (CNNs), recurrent neural networks (RNNs), or any other type of specially trained neural networks that are configured to process and/or employ the one or more audio signals 302a-n. Additionally or alternatively, in certain embodiments, the acoustic source identification model 320 may comprise, employ, direct, and/or otherwise integrate with one or more Gaussian mixture models (GMM) 322 configured as voice recognition models, facial recognition models 324, frequency- and time-domain linear prediction models 326, speech transformation models 328, computer vision models, speech-to-text models, text-to-speech models, and/or adaptive transcript models.

The acoustic source identification model 320 may employ the one or more discrete AI models configured to execute one or more respective ML techniques for executing one or more derived applications associated with embodiments herein. For example, the acoustic source identification model 320 may comprise one or more discrete AI models configured to generate and/or determine a user audio profile 308 associated with a particular acoustic source, generate a voice feature vector 310 related to a speaking voice associated with the acoustic source, apply a personalized equalization (EQ) to audio signals 302a-n generated by a particular identified acoustic source, apply a personalized voice lift to audio signals 302a-n generated by a particular identified acoustic source, apply a personalized microphone lobe priority to a particular identified acoustic source, and/or generate a live transcript associated with one or more portions of speech comprised in respective audio signals 302a-n generated by a particular identified acoustic source 108.

In various examples, an acoustic source identification model 320 (and/or the one or more models associated with the acoustic source identification model 320) may be trained in part using one or more portions of labeled audio signal data. The one or more portions of labeled audio signal data can include human speech signals, audio signals 302a-n associated with various musical instruments, portions of user audio profile 308 data, and/or voice feature vectors 310.

In various examples, the acoustic source identification model 320 may be configured to determine, based on one or more audio signals 302a-n generated by the acoustic source 108, that the acoustic source is a human speaker (e.g., a performer, instructor, member of an organization, self-help coach, and/or the like). Furthermore, in various examples, the acoustic source identification model 320 may be configured to determine a user audio profile 308 associated with the human speaker based on the one or more audio signals 302a-n generated by the human speaker (e.g., acoustic source 108). In one or more examples, a user audio profile 308 associated with a human speaker may include a voice feature vector 310, an EQ preference set 312, a priority level 314, a user identifier, one or more portions of user contact data, an organizational identifier, and/or one or more portions of image data 318 associated with the human speaker. In this regard, the acoustic source identification model 320, in conjunction with the apparatus 120, may be configured to, based on one or more portions of data comprised in a user audio profile 308 associated with an identified human speaker, identify a human speaker and determine the user audio profile 308 associated with the human speaker based on one or more audio signals 302a-n generated by the human speaker.

In some examples, the acoustic source identification model 320 may be configured to describe parameters, hyper-parameters, and/or stored operations of a trained AI model that is configured to process a plurality of audio signals 302a-n comprising one or more speech signals generated by a human speaker (e.g., acoustic source 108) to generate a voice feature vector 310 representative of a speaking voice associated with the human speaker. The acoustic source identification model 320 may be configured to extract, determine, decode, and/or derive one or more portions of voice feature data 306 from one or more audio signals 302a-n generated by the human speaker.

The one or more portions of voice feature data 306 may include a cepstral representation of speech. A cepstral representation of speech may include Mel-frequency cepstral coefficients (MFCC), frequencies, pitches, frequency patterns, speech patterns, timbres, and/or vocal tract resonances. In some examples, the acoustic source identification model 320 can be configured to apply one or more DSP techniques to optimize the extraction, determination, decoding and/or derivation of the one or more portions of voice feature data 306 from one or more audio signals 302a-n generated by the human speaker.

In some examples, the acoustic source identification model 320 may be configured to generate a voice feature vector 310 in real-time based on one or more audio signals 302a-n generated by the human speaker. For example, generating the voice feature vector 310 in real-time may be a part of an initialization and/or setup process associated with a respective acoustic source identification and tracking system 100a associated with a particular acoustic environment 101a. A live self-help seminar being held in a particular acoustic environment 101a may comprise a plurality of human speakers not yet associated with (e.g., enrolled in) the acoustic source identification and tracking system 100a. As part of an initialization and/or setup process associated with the acoustic source identification and tracking system, the one or more human speakers may be prompted to generate audio signals 302a-n (e.g., speak) proximate to a tracking zone (e.g., tracking zone 104b) associated with a steerable microphone array (e.g., steerable microphone array 102e) so that the acoustic source identification model 320 may generate a voice feature vector 310 for the respective human speakers in real-time (e.g., as the human speakers are speaking).

In some examples, the acoustic source identification model 320 may be configured to generate a voice feature vector 310 for a human speaker that has not executed an initialization and/or setup process. For example, the acoustic source identification model 320 may generate the respective voice feature vector 310 during a first speech given by the human speaker during a live presentation.

In some examples, the acoustic source identification model 320 may be configured to, in conjunction with the apparatus 120, identify a human speaker based on one or more portions of acoustic source identification model output 330. The one or more portions of acoustic source identification model output 330 may comprise one or more portions of mixture model output, facial recognition output, frequency-and time-domain linear prediction output, voice recognition output, computer vision model output, and/or any other type of machine learning model output generated by the one or more discrete AI models associated with the acoustic source identification model 320.

The acoustic source identification model 320 associated with the acoustic source identification and tracking system may be configured to, in conjunction with the apparatus 120, identify the human speaker based on one or more portions of mixture model output generated by a GMM 322 associated with the acoustic source identification model 320, where the mixture model output is generated based on inputting one or more portions of voice feature data 306 associated with the one or more audio signals 302a-n generated by the human speaker into the GMM 322. In some examples, one or more voice feature vectors 310 may be used in part to train, retrain, and/or update a GMM 322 associated with the acoustic source identification model 320. As such, the GMM 322, and therefore the acoustic source identification model 320, may be iteratively improved as more voice feature vectors 310 are generated and/or used to train, retrain, and/or update the GMM 322.

In some examples, the acoustic source identification model 320 may be configured to, in conjunction with the apparatus 120, identify a human speaker based on one or more portions of frequency and time domain linear prediction output. The one or more portions of frequency and time domain linear prediction output may be generated based on inputting one or more portions of audio data associated with the one or more audio signals 302a-n generated by the human speaker into a frequency- and time-domain linear prediction model 326 associated with the acoustic source identification model 320.

In some examples, the acoustic source identification model 320 may be configured to, in conjunction with the apparatus 120, identify a human speaker based on one or more portions of facial recognition output generated by a facial recognition model 324 associated with the acoustic source identification model 320. The facial recognition output may be generated based on inputting one or more portions of image data 318 associated with the human speaker into the facial recognition model 324. For example, one or more portions of image data 318 associated the human speaker may be captured by the image capturing device 116 and input into the facial recognition model 324 associated with the acoustic source identification model 320 in order to facilitate identifying the human speaker. In various examples, the facial recognition model 324 may compare the one or more portions of image data 318 associated with the human speaker captured by the image capturing device 116 to one or more portions of image data 318 comprised in the user audio profile 308 associated with the human speaker.

In some examples, the acoustic source identification model 320 may be configured to rank the one or more identified acoustic sources of the plurality of acoustic sources based on a priority level 314 indicated in the user audio profile 308 associated with the one or more respective acoustic sources. For example, if the plurality of acoustic sources (e.g., the plurality of human speakers, acoustic sources 108a-d) belong to the same organization, the user audio profiles 308 associated with the respective acoustic sources may comprise a priority level 314 associated with, for example, an organizational hierarchy.

The first acoustic source (e.g., the acoustic source 108a) may be the CEO of an organization associated with the plurality of acoustic sources (e.g., the acoustic sources 108a-d), whereas a second acoustic source (e.g., acoustic source 108b) may be a staff member of said organization. In this example scenario, the user audio profile 308 associated with the first acoustic source (e.g., the CEO, acoustic source 108a) may comprise priority level 314 (e.g., a value, indication, keyword, and/or the like) indicating that the first acoustic source has a higher priority relative to the second acoustic source (e.g., the acoustic source 108b). As such, the apparatus 120 may rank the first acoustic source higher than the second acoustic source. In various examples, the apparatus 120 may be configured to generate a priority list comprising a ranked list, structure, and/or organizational representation of one or more acoustic sources (e.g., acoustic sources 108a-d) based on the priority level 314 associated with the one or more acoustic sources.

In some examples, the acoustic source identification model 320 may be configured to determine that a human speaker (e.g., acoustic source 108a) is a primary acoustic source of a plurality of acoustic sources (e.g., acoustic sources 108a-108d) generating respective audio signals 302a-n within an acoustic environment 101b. In various examples, the acoustic source identification model 320 may determine that the first acoustic source is a primary acoustic source based on portions of user audio profile 308 data retrieved after the identification of the first acoustic source, a ranking associated with the first acoustic source, a priority level 314 associated with the first acoustic source, a priority list associated with the plurality of acoustic sources, a detected RFID tag associated with the first acoustic source, one or more portions of mixture model output generated based on one or more portions of voice feature data 306 associated with the first acoustic source, and/or one or more portions of image data 318 associated with the first acoustic source.

In various examples, the acoustic source identification model 320 may be configured to augment (e.g., by using the apparatus 120) one or more audio signals 302a-n generated by the primary acoustic source and/or one or more other acoustic sources of the plurality of acoustic sources in the acoustic environment 101b. For example, the acoustic source identification model 320 may apply (e.g., by using the apparatus 120) a personalized voice lift to the one or more audio signals 302a-n generated by the primary acoustic source such that the speaking voice of the primary acoustic source is augmented (e.g., the audio signals 302a-n associated with the speaking voice of the primary acoustic source are boosted, mixed, equalized, filtered, and/or otherwise affected).

The acoustic source identification model 320 may augment (e.g., by using the apparatus 120) one or more audio signal attributes 304a-n (e.g., gain, volume, pitch, and/or the like) associated with the one or more audio signals 302a-n generated by the primary acoustic source relative to other audio signals 302a-n generated by the one or more other acoustic sources based on the personalized voice lift. As such, the speaking voice of the primary acoustic source may be augmented to be more prevalent relative to the speaking voices of the one or more other acoustic sources in the acoustic environment upon output of the audio signals 302a-n generated by the plurality of acoustic sources (e.g., upon output of the audio signals 302a-n via a speaker array associated with the acoustic environment).

The acoustic source identification model 320 may generate (e.g., by using the apparatus 120) personalized microphone lobe priority. In various examples, the personalized microphone lobe priority can be associated with a respective microphone lobe (e.g., microphone lobe 106k) of one or more microphone lobes (e.g., microphone lobes 106a-n) and is configured to facilitate the prioritization of one or more audio signals 302a-n generated within range of the respective microphone lobe associated with the personalized microphone lobe priority.

In various examples, the acoustic source identification model 320 may augment (e.g., by using the apparatus 120) one or more audio signal attributes 304a-n associated with the one or more audio signals 302a-n generated by the specific acoustic source relative to other audio signals 302a-n generated by other acoustic sources of the one or more acoustic sources in the acoustic environment based on the personalized microphone lobe priority. For example, similar to the methods described herein related to the application of the personalized voice lift to the audio signals 302a-n associated with the speaking voice of an identified human speaker, the audio signals 302a-n captured by way of a microphone lobe 106k associated with the personalized microphone lobe priority applied to the acoustic source 108a may be boosted, mixed, equalized, filtered, and/or otherwise affected. As such, the audio signals 302a-n captured by way of the microphone lobe 106k associated with the personalized microphone lobe priority applied to the acoustic source 108a may be augmented to be more prevalent (e.g., louder, more present, etc.) relative to the other audio signals 302a-n generated by the one or more other acoustic sources.

In some examples, the acoustic source identification model 320 may augment (e.g., by using the apparatus 120) the other audio signals 302a-n generated by the other acoustic sources based on the personalized microphone lobe priority associated with the acoustic source 108a. For example, in some embodiments, the acoustic source identification model 320 may augment the mixing, filtering, equalization, volume, gain, pitch, frequencies, and/or the like related to the one or more audio signals 302a-n generated by the other acoustic sources 108b-d not associated with the personalized microphone lobe priority.

In some examples, the acoustic source identification model 320 may augment (e.g., by using the apparatus 120) the other audio signals 302a-n generated by the other acoustic sources 108b-d based on a priority list associated with the one or more acoustic sources in the acoustic environment. For example, the degree to which the other audio signals 302a-n associated with the other respective acoustic sources are augmented may be determined based on a position of the respective acoustic sources on the priority list. As an example, the lower a particular acoustic source is on the priority list, the more the volume associated with the audio signals 302a-n associated with the particular acoustic source may be reduced. In various examples, the priority list is generated based on a ranking of the one or more respective acoustic sources. In some examples, the ranking is based on the priority level 314 indicated in the user audio profile 308 associated with the one or more respective acoustic sources.

In various examples, the acoustic source identification model 320 may comprise and/or integrate with a speech transformation model 328 trained to generate a speech vector representation of one or more words comprised within the audio signals 302a-n generated by a respective acoustic source (e.g., a respective human speaker, acoustic source 108a). The speech vector representation may comprise the one or more words comprised within the audio signals 302a-n as well as the manner in which the words were spoken. For example, the acoustic source identification model 320 can be trained to detect one or more of vocal pitch, articulation, pause duration, pace, volume, intensity, and/or rate associated with the one or more words spoken by the acoustic source 108a. Additionally, the acoustic source identification model 320 can be trained to detect one or more emotive qualities associated with the one or more words including, but not limited to, valence qualities, activation qualities, and/or dominance qualities. In certain embodiments, the acoustic source identification model 320 can be configured to apply one or more DSP techniques to optimize the extraction of the one or more speech primitives associated with the one or more words spoken by the acoustic source 108a.

In some examples, the acoustic source identification model 320 may be trained to extract one or more speech primitives comprising the one or more words spoken by the acoustic source 108a and convert the one or more speech primitives into a computer-readable format. The one or more speech primitives are one or more distinct portions of human speech generated by the acoustic source 108a captured by the one or more steerable microphone arrays 102a-n. The one or more speech primitives are converted into electronically managed representations (e.g., data objects) of the one or more respective words spoken by the acoustic source 108a and can be employed by the acoustic source identification model 320 to execute various processes.

In some examples, the acoustic source identification model 320 may be configured to generate, based on inputting one or more speech vector representations associated with one or more respective acoustic sources 108a-d into an adaptive transcript model, a live transcript associated with the one or more audio signals 302a-n generated by the one or more respective acoustic sources. The live transcript may include, but is not limited to, one or more portions of data related to one or more user audio profiles 308 associated with the one or more respective acoustic sources (e.g., a voice feature vector 310, a priority level 314, user identification data 316, and/or or an organizational identifier). As such, the acoustic source identification model 320 may be configured to determine one or more speaker attributions associated with the one or more words spoken by the one or more respective acoustic sources 108a-d.

In various examples, the live transcript comprises one or more portions of textual data associated with the one or more words spoken by the one or more respective acoustic sources. Additionally, the live transcript may comprise one or more portions of timestamp data related to the one or more words spoken by the one or more respective acoustic sources such that the timestamp data may be used by the adaptive transcript model to organize and/or structure the live transcript.

In various examples, the live transcript may comprise location data associated with the one or more respective acoustic sources 108a-d. The location data may comprise one or more portions of positional data (e.g., one or more coordinates) associated with the acoustic source within the acoustic environment. As such, the acoustic source identification model 320 may be configured to generate an acoustic source map related to the relative locations of the acoustic sources based on the location data comprised within the live transcript. Additionally or alternatively, the acoustic source identification model 320 may be able to chart a path 110b traversed by the acoustic sources based on the location data associated with the acoustic sources and/or the timestamp data associated with the words spoken by the respective acoustic sources.

In some examples, the acoustic source identification model 320 may be configured to generate an event summary based on inputting one or more speech vector representations associated with one or more respective acoustic sources into the adaptive transcript model. The event summary can include, but is not limited to, at least one of one or more speech transcripts (e.g., generated based one or more respective live transcripts), one or more portions of audio data recorded as the acoustic sources generated respective audio signals 302a-n in the acoustic environment, and/or one or more portions of image data 318 (e.g., video data) captured by an image capturing device 116.

In various examples, the acoustic source identification model 320 may be configured to generate one or more portions of action item data based on the event summary. As such, the acoustic source identification model 320 may be configured to generate an action item list (e.g., a list of tasks) for each acoustic source of the one or more respective acoustic sources 108a-d. Furthermore, the acoustic source identification model 320 may be configured to transmit, based on the user audio profile 308 associated with the one or more respective acoustic sources, the action item list to each acoustic source of the one or more respective acoustic sources. For example, the acoustic source identification model 320 may be configured to email the action item list to the respective acoustic sources. As another example, the acoustic source identification model 320 may be configured to upload the action item list to a server system associated with an organization related to the acoustic sources such that the acoustic sources can access the action item list.

In some examples, the acoustic source identification model 320 may be configured to continuously track an acoustic source 108a with an image capturing device 116 as the acoustic source traverses the acoustic environment 101b. For example, the image capturing device 116 may be configured to follow the acoustic source 108a as the acoustic source 108a navigates the acoustic environment 101b based on an orientation of a respective microphone lobe of the one or more microphone lobes 106a-n that has been directed toward, or assigned to, the acoustic source 108a. The apparatus 120 may be further configured to direct one or more microphone lobes 106a-n towards an acoustic source 108a based on one or more portions of image data 318 captured by the image capturing device 116.

As such, the image capturing device 116 may be configured to capture one or more portions of image data 318 (e.g., video data) associated with the acoustic source 108a as the image capturing device tracks the acoustic source 108a as the acoustic source 108a navigates the acoustic environment 101b. The apparatus 120 can cause display (e.g., on one or more screens) of the one or more portions of image data 318 (e.g., video data) captured by the image capturing device 116 as the acoustic source 108a navigates the acoustic environment 101b.

In addition to causing display of the one or more portions of image data 318 (e.g., video data) related to the acoustic source 108a, the apparatus 120 may be configured to simultaneously cause display of a live transcript associated with one or more words spoken by the acoustic source. For example, the one or more portions of image data 318 (e.g., video data) related to the acoustic source 108a may be displayed on a screen situated in the acoustic environment 101b in real-time along with the live transcript associated with one or more words spoken by the acoustic source 108a. In this manner, one or more audience members (e.g., situated in audience accommodations 114) may be able to read the live transcript while viewing the one or more portions of image data 318 (e.g., video data).

In various examples, the acoustic source identification model 320 may be configured to (e.g., by using the apparatus 120) cause display of the text of a first live transcript associated with words spoken by a first acoustic source (e.g., acoustic source 108a) over one or more portions of first image data 318 (e.g., first video data) associated with the first acoustic source, and simultaneously display the text of a second live transcript associated with one or more words spoken by a second acoustic source (e.g., acoustic source 108b) over one or more portions of second image data 318 (e.g., second video data) associated with the second acoustic source while the first and second acoustic source are speaking in the same acoustic environment. The acoustic source identification model 320 may be configured to (e.g., by using the apparatus 120) generate and/or facilitate the output of simultaneous, respective video feeds related to the acoustic sources while simultaneously causing display of respective live transcripts associated with the respective acoustic sources.

### Example Methods for Acoustic Source Identification and Tracking

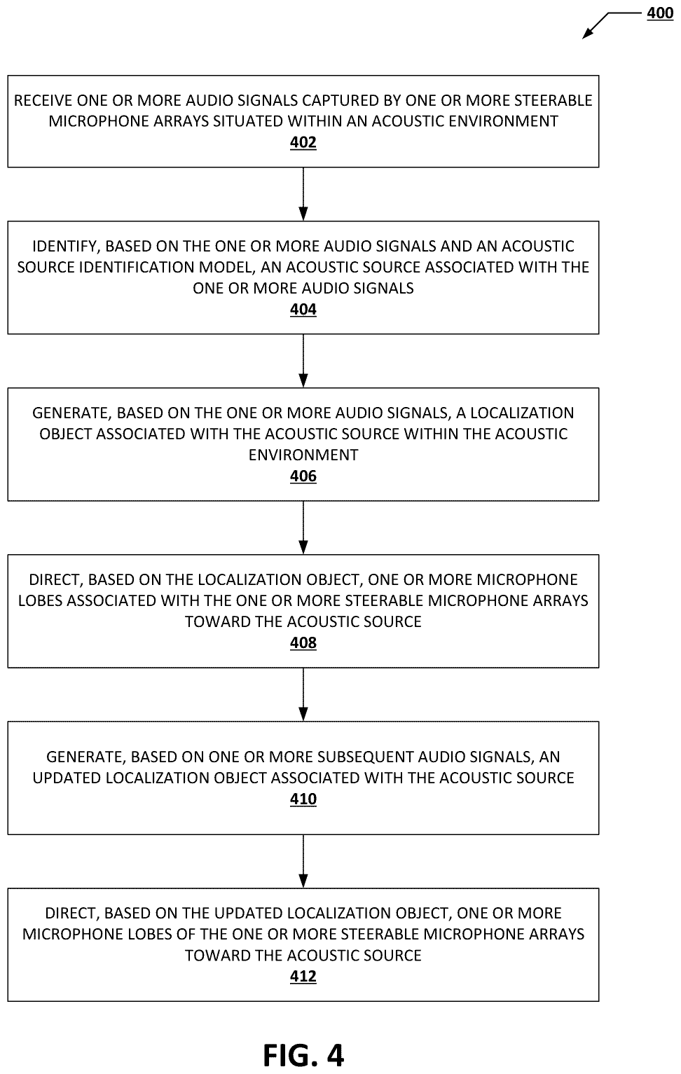

FIG. 4 illustrates an example method 400 for the identification and continuous tracking of an acoustic source in a respective acoustic environment in accordance with one or more embodiments disclosed herein. The method 400 can be implemented by one or more components of an apparatus 120. As described herein, the apparatus 120 can be integrated with, in communication with, and/or associated with one or more components of a particular acoustic environment 101a-b. It will be appreciated that the apparatus 120 may be configured to perform the method 400 with reference to the components of the apparatus 120. As such, the apparatus 120 includes means, such as the processor 202, the memory 204, the acoustic source tracking circuitry 206, the machine learning model circuitry 208, the input/output circuitry 210, the communications circuitry 212, and/or the like, configured to perform the various operations associated with the method 400.

The method 400 begins at operation 402 in which the apparatus 120 is configured to receive one or more audio signals 302a-n captured by one or more steerable microphone arrays 102a-n situated within a respective acoustic environment 101a-n. For example, one or more steerable microphone arrays 102a-n may be positioned in various known locations of an acoustic environment 101a configured as a lecture hall. The one or more steerable microphone arrays 102a-n may be associated with various acoustic environment features in the acoustic environment such as, for example, a podium, whiteboard, and/or the like.

At operation 404 the apparatus 120 is configured to identify, based on inputting the one or more audio signals 302a-n into an acoustic source identification model 320, an acoustic source 108 associated with the one or more audio signals 302a-n. For example, the acoustic source identification model 320 may identify that an acoustic source 108 is a particular professor. The particular professor may be identified based on one or more portions of voice feature data 306 comprised within the one or more audio signals 302a-n. The acoustic source identification model 320 may input the one or more portions of voice feature data 306 associated with the audio signals 302a-n into a GMM 322. Based on one or more portions of mixture model output generated by the GMM 322, the acoustic source identification model 320 can determine the identity of the professor (e.g., the acoustic source 108). The professor may be identified based on at least one or more of facial recognition output, frequency- and time-domain output, RFID detection, and/or the like.

At operation 406 the apparatus 120 is configured to generate, based on the one or more audio signals 302a-n, a localization object associated with the acoustic source 108 within the acoustic environment. For example, as the professor (e.g., the acoustic source 108) gives a presentation in the lecture hall, the apparatus 120 can generate a localization object comprising positional data (e.g., one or more coordinates) associated with the professor.

At operation 408 the apparatus 120 is configured to direct, based on the localization object, one or more microphone lobes 106a-n associated with the one or more steerable microphone arrays 102a-n toward the acoustic source 108. For example, the apparatus 120 can use the localization object to direct one or more microphone lobes 106a-n toward the professor (e.g., the acoustic source 108) such that the steerable microphone arrays 102a-n can capture the desired audio signals 302a-n (e.g., speech signals) generated by the professor during the presentation.

At operation 410 the apparatus 120 is configured to generate, based on one or more subsequent audio signals 302a-n, an updated localization object associated with the acoustic source 108. For example, as the professor (e.g., the acoustic source 108) navigates the lecture hall, such as, from the podium (e.g., acoustic environment feature 112a) to the whiteboard (e.g., acoustic environment feature 112b), the apparatus 120 can generate updated localization objects associated with the subsequent locations of the professor.

At operation 412 the apparatus 120 is configured to direct, based on the updated localization object, the one or more microphone lobes 106a-n of the one or more steerable microphone arrays 120a-n toward the acoustic source 108. For example, the apparatus 120 can use the updated localization objects to direct one or more microphone lobes 106a-n toward the professor (e.g., the acoustic source 108) such that the one or more steerable microphone arrays 102a-n can capture the audio signals 302a-n generated by the professor. In this way, the apparatus 120 can continuously track the professor (e.g., the acoustic source 108) throughout the course of the presentation without failing to capture any desired audio signals 302a-n generated by the professor.

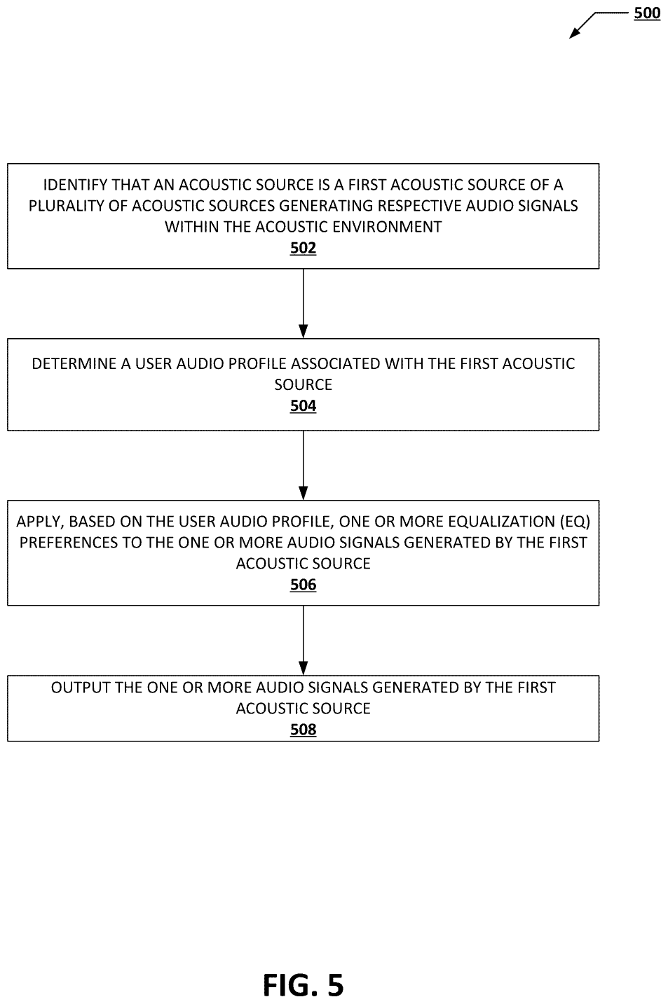

FIG. 5 illustrates an example method 500 for applying a personalized equalization (EQ) to one or more audio signals 302a-n generated by a respective acoustic source in accordance with one or more embodiments disclosed herein. The method 500 can be implemented by one or more components of an apparatus 120. As described herein, the apparatus 120 can be integrated with, in communication with, and/or associated with one or more components of a particular acoustic environment 101a-b.

The method 500 begins at operation 502 in which the apparatus 120 is configured to identify that an acoustic source 108a is a first acoustic source of a plurality of acoustic sources 108a-n generating respective audio signals 302a-n within the acoustic environment. For example, the first acoustic source (e.g., acoustic source 108a) may be a first human speaker of a plurality of human speakers (e.g., acoustic sources 108a-d) generating respective audio signals 302a-n on a stage (e.g., acoustic environment feature 112c) during a seminar presentation.

The method 500 continues, at operation 504, where the apparatus 120 is configured to determine a user audio profile 308 associated with the first acoustic source 108a. In various examples, a plurality of user audio profiles 308 can be generated for a respective plurality of acoustic sources 108a-n associated with an acoustic source identification and tracking system 100b. As such, the apparatus 120 can employ the acoustic source identification model 320 to determine a respective use audio profile associated the first acoustic source 108a.

The method 500 continues, at operation 506, where the apparatus 120 is configured to apply, based on the user audio profile 308, one or more EQ preferences to the one or more audio signals 302a-n generated by the first acoustic source 108a. For example, the use audio profile associated with the first acoustic source 108a may comprise one or more of a voice feature vector 310, an EQ preference set 312, a priority level 314, a user identifier, portions of user contact data, an organizational identifier, or portions of image data 318. As such, the apparatus 120 can apply one or more EQ preferences comprised within the EQ preference set 312 associated with the user audio profile 308 to the one or more audio signals 302a-n. The first acoustic source 108a may prefer to have one or more bass frequencies removed from the respective audio signals 302a-n such that a speaking voice of the first acoustic source 108a will have a greater clarity (e.g., a less “boomy” or “muddy” presence) when output in a respective acoustic environment 101b.

The method 500 continues, at operation 508, where the apparatus 120 is configured to output the one or more audio signals 302a-n generated by the first acoustic source 108a. In various examples, the apparatus 120 can cause the output and/or transmission of the audio signals 302a-n generated by the first acoustic source 108a. The apparatus 120 may cause the audio signals 302a-n to be output by a speaker array system associated with the acoustic environment 101b. The apparatus may cause the audio signals 302a-n to be transmitted to one or more external computing devices via the network 122.

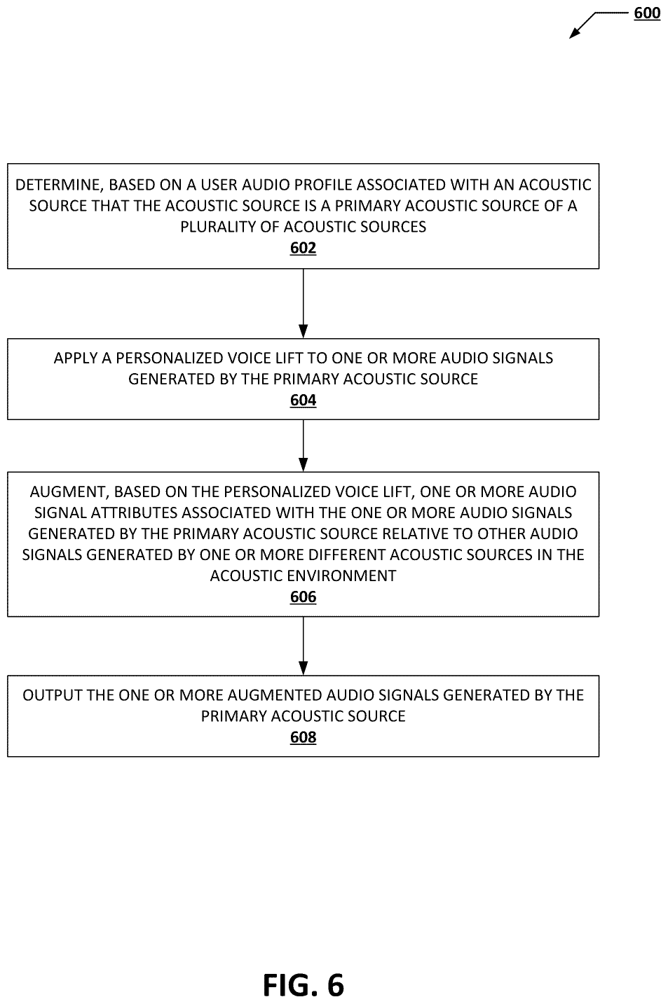

FIG. 6 illustrates an example method 600 for applying a personalized voice lift to one or more audio signals 302a-n generated by a respective acoustic source in accordance with one or more embodiments disclosed herein. The method 600 can be implemented by one or more components of an apparatus 120. As described herein, the apparatus 120 can be integrated with, in communication with, and/or associated with one or more components of a particular acoustic environment 101a-b.

The method 600 begins at operation 602 in which the apparatus 120 is configured to determine, based on a user audio profile 308 associated with an acoustic source 108a that the acoustic source 108a is a primary acoustic source of a plurality of acoustic sources 108a-n. In various examples, an acoustic source 108a may be determined to be a primary acoustic source based on one or more portions of priority level 314, organization hierarchy data, and/or ranking data associated with the user audio profile 308 associated with the acoustic source 108a. The acoustic source 108a may be determined to be a primary acoustic source based on a priority list associated with the plurality of acoustic sources 108a-d.

The method 600 continues, at operation 604, where the apparatus 120 is configured to apply a personalized voice lift to one or more audio signals 302a-n generated by the primary acoustic source. For example, the speaking voice of the acoustic source 108a may be augmented such that the audio signals 302a-n associated with the speaking voice of the acoustic source 108a are boosted, mixed, equalized, filtered, and/or otherwise affected.

The method 600 continues, at operation 606, where the apparatus 120 is configured to augment, based on the personalized voice lift, one or more audio signal attributes 304a-n associated with the one or more audio signals 302a-n generated by the primary acoustic source (e.g., acoustic source 108a) relative to other audio signals 302a-n generated by one or more different acoustic sources (e.g., acoustic sources 108b-d) in the acoustic environment. For example, the apparatus 120 may augment one or more of a gain, volume, and/or a pitch associated with the one or more audio signals 302a-n generated by the acoustic source 108a relative to other audio signals 302a-n generated by the one or more other acoustic sources 108b-d.

The method 600 continues, at operation 608, where the apparatus 120 is configured to output the one or more augmented audio signals 302a-n generated by the primary acoustic source (e.g., the acoustic source 108a). For example, the apparatus 120 may cause output of the one or more augmented audio signals 302a-n via a speaker array system associated with the acoustic environment 101b. In some examples, the apparatus 120 may cause transmission of the one or more augmented audio signals 302a-n to one or more external computing devices via the network 122.

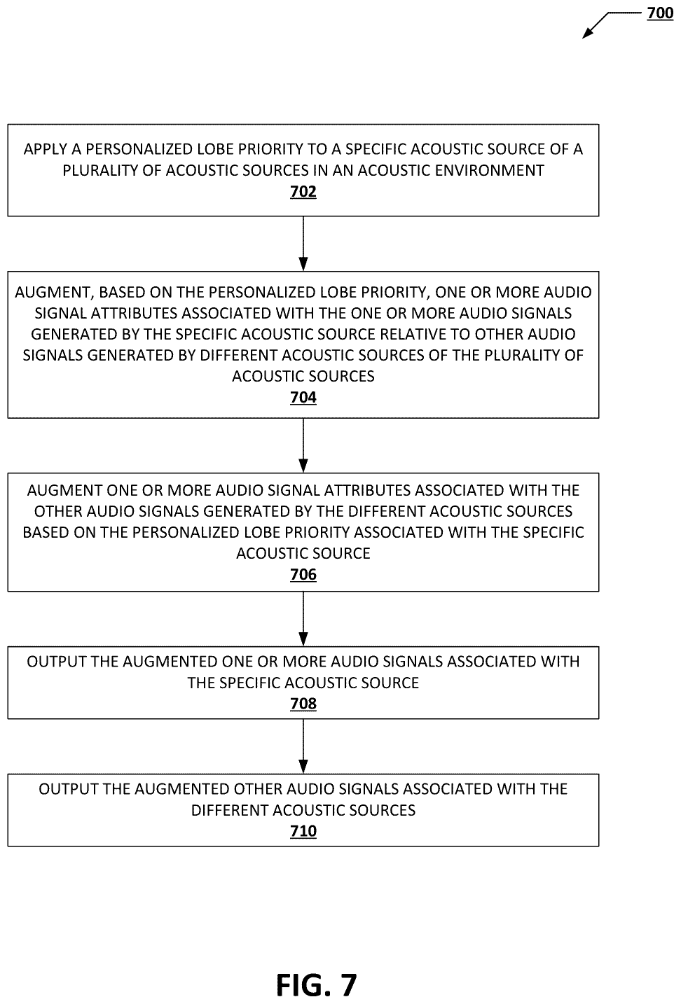

FIG. 7 illustrates an example method 700 for applying a personalized microphone lobe priority to a specific acoustic source of a plurality of acoustic sources in accordance with one or more embodiments disclosed herein. The method 700 can be implemented by one or more components of an apparatus 120. As described herein, the apparatus 120 can be integrated with, in communication with, and/or associated with one or more components of a particular acoustic environment 101a-b.

The method 700 begins at operation 702 in which the apparatus 120 is configured to apply a personalized microphone lobe priority to a specific acoustic source of a plurality of acoustic sources 108a-n in an acoustic environment 101b. For example, the apparatus 120 may apply the personalized microphone lobe priority to the acoustic source 108a upon the determination that the acoustic source 108a is a primary acoustic source among one or more other acoustic sources 108a-d.

The method 700 continues, at operation 704, where the apparatus 120 is configured to augment, based on the personalized microphone lobe priority, one or more audio signal attributes 304a-n associated with the one or more audio signals 302a-n generated by the acoustic source 108a relative to other audio signals 302a-n generated by different acoustic sources 108d-b of the plurality of acoustic sources 108a-d. For example, the audio signals 302a-n captured by way of a microphone lobe 106f associated with the personalized microphone lobe priority applied to the acoustic source 108a may be boosted, mixed, equalized, filtered, and/or otherwise affected to be more prevalent, louder, and/or present relative to the other audio signals 302a-n generated by the one or more other acoustic sources 108b-d.

The method 700 continues, at operation 706, where the apparatus 120 is configured to augment one or more audio signal attributes 304a-n associated with the other audio signals 302a-n generated by the different acoustic sources 108a-d based on the personalized microphone lobe priority associated with the specific acoustic source 108a. For example, the apparatus 120 may augment the mixing, filtering, equalization, volume, gain, pitch, frequencies, and/or the like related to the one or more audio signals 302a-n generated by the other acoustic sources 108b-d not associated with the personalized microphone lobe priority.

The method 700 continues, at operation 708, where the apparatus 120 is configured to output the augmented one or more audio signals 302a-n associated with the acoustic source 108a. For example, the apparatus 120 may cause output of the one or more augmented audio signals 302a-n associated with the acoustic source 108a via a speaker array system associated with the acoustic environment 101b. In some examples, the apparatus 120 may cause transmission of the one or more augmented audio signals 302a-n to one or more external computing devices via the network 122.

The method 700 continues, at operation 710, where the apparatus 120 is configured to output the augmented other audio signals 302a-n associated with the other one or more acoustic sources 108b-d. For example, the apparatus 120 may cause output of the one or more augmented audio signals 302a-n associated with the other one or more acoustic sources 108b-d via a speaker array system associated with the acoustic environment 101b. The apparatus 120 may cause transmission of the one or more augmented audio signals 302a-n to one or more external computing devices via the network 122.

Embodiments disclosed herein are described with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Hereinafter, various characteristics will be highlighted in a set of numbered clauses or paragraphs. These characteristics are not to be interpreted as being limiting on the disclosure or inventive concept but are provided merely as a highlighting of some characteristics as described herein, without suggesting a particular order of importance or relevancy of such characteristics.

Clause 1. An apparatus comprising at least one processor and a memory storing instructions that are operable, when executed by the at least one processor, to cause the apparatus to: receive one or more audio signals captured by one or more steerable microphone arrays situated within an acoustic environment; identify, based on the one or more audio signals and an acoustic source identification model, an acoustic source associated with the one or more audio signals; generate, based on the one or more audio signals, a localization object associated with the acoustic source within the acoustic environment; direct, based on the localization object, one or more microphone lobes associated with the one or more steerable microphone arrays toward the acoustic source; generate, based on one or more subsequent audio signals, an updated localization object associated with the acoustic source; and direct, based on the updated localization object, the one or more microphone lobes of the one or more steerable microphone arrays toward the acoustic source.

Clause 2. An apparatus according to the foregoing Clause, wherein each steerable microphone array of the one or more steerable microphone arrays is associated with a known location within the acoustic environment.

Clause 3. An apparatus according to any one of the foregoing Clauses, wherein the localization object comprises a location of the acoustic source within the acoustic environment.

Clause 4. An apparatus according to any one of the foregoing Clauses, wherein the one or more microphone lobes are directed toward the acoustic source based on one or more audio signal attributes associated with the one or more audio signals.

Clause 5. An apparatus according to any one of the foregoing Clauses, wherein the one or more audio signal attributes comprise one or more of acoustic features comprising one or more of an angle of arrival, a gain, a frequency, a pitch, a timbre, an articulation, a volume, or an intensity, emotive qualities comprising one or more of a valence, an activation, or a dominance, or speech delivery characteristics comprising one or more of a pause duration, a pace, or a speech rate.

Clause 6. An apparatus according to any one of the foregoing Clauses, wherein the one or more microphone lobes are directed toward the acoustic source based on an orientation of the acoustic source relative to a tracking zone associated with a respective steerable microphone array of the one or more steerable microphone arrays.

Clause 7. An apparatus according to any one of the foregoing Clauses, wherein the tracking zone is associated with an audio capture coverage area of the respective steerable microphone array.

Clause 8. An apparatus according to any one of the foregoing Clauses, wherein a first microphone lobe of a first steerable microphone array is directed toward the acoustic source based on a first plurality of audio signal attributes associated with a first plurality of audio signals.

Clause 9. An apparatus according to any one of the foregoing Clauses, wherein the first plurality of audio signals is generated within range of a first tracking zone associated with the first steerable microphone array.

Clause 10. An apparatus according to any one of the foregoing Clauses, wherein the one or more microphone lobes are directed toward the acoustic source based on one or more portions of image data associated with the acoustic source, and wherein the one or more portions of image data are captured by an image capturing device situated in the acoustic environment.

Clause 11. An apparatus according to any one of the foregoing Clauses, wherein the instructions that are operable when executed by the at least one processor further cause the apparatus to: determine that the acoustic source is navigating toward a second tracking zone associated with a second steerable microphone array.

Clause 12. An apparatus according to any one of the foregoing Clauses, wherein a second microphone lobe of the second steerable microphone array is directed toward the acoustic source based on a second plurality of audio signal attributes associated with a second plurality of audio signals.

Clause 13. An apparatus according to any one of the foregoing Clauses, wherein the second plurality of audio signals is generated within range of the second tracking zone associated with the second steerable microphone array.

Clause 14. An apparatus according to any one of the foregoing Clauses, wherein the acoustic source identification model is trained in part using one or more portions of labeled audio signal data comprising one or more of human speech signals, audio signals associated with various musical instruments, portions of user audio profile data, or voice feature vectors.

Clause 15. An apparatus according to any one of the foregoing Clauses, wherein the instructions that are operable when executed by the at least one processor further cause the apparatus to: identify that the acoustic source is a first acoustic source of one or more acoustic sources generating respective audio signals within the acoustic environment.

Clause 16. An apparatus according to any one of the foregoing Clauses, wherein the instructions that are operable when executed by the at least one processor further cause the apparatus to: determine that the acoustic source is a human speaker; and determine a user audio profile associated with the human speaker.

Clause 17. An apparatus according to any one of the foregoing Clauses, wherein the instructions that are operable when executed by the at least one processor further cause the apparatus to: apply, based on the user audio profile, one or more equalization (EQ) preferences to the one or more audio signals generated by the human speaker.

Clause 18. An apparatus according to any one of the foregoing Clauses, wherein the user audio profile comprises one or more of a voice feature vector, an EQ preference set, a priority level, a user identifier, portions of user contact data, an organizational identifier, or portions of image data associated with the human speaker.

Clause 19. An apparatus according to any one of the foregoing Clauses, wherein the voice feature vector is related to a speaking voice associated with the human speaker.

Clause 20. An apparatus according to any one of the foregoing Clauses, wherein the voice feature vector comprises one or more portions of voice feature data comprising one or more of Mel-frequency cepstral coefficients (MFCC), frequencies, pitches, frequency patterns, speech patterns, timbres, or vocal tract resonances.

Clause 21. An apparatus according to any one of the foregoing Clauses, wherein the portions of voice feature data are extracted by the acoustic source identification model from one or more audio signals generated by the human speaker.

Clause 22. An apparatus according to any one of the foregoing Clauses, wherein the voice feature vector is used at least in part to train a Gaussian mixture model (GMM) associated with the acoustic source identification model.

Clause 23. An apparatus according to any one of the foregoing Clauses, wherein the voice feature vector is generated by the acoustic source identification model as the one or more audio signals are generated by the human speaker.

Clause 24. An apparatus according to any one of the foregoing Clauses, wherein the instructions that are operable when executed by the at least one processor further cause the apparatus to: identify the human speaker based on detecting a radio frequency identification (RFID) tag, wherein the RFID tag is associated with the user audio profile associated with the human speaker.

Clause 25. An apparatus according to any one of the foregoing Clauses, wherein the instructions that are operable when executed by the at least one processor further cause the apparatus to: identify the human speaker based on one or more portions of facial recognition output generated by a facial recognition model associated with the acoustic source identification model.

Clause 26. An apparatus according to any one of the foregoing Clauses, wherein the instructions that are operable when executed by the at least one processor further cause the apparatus to: identify the human speaker based on one or more portions of mixture model output generated by a GMM associated with the acoustic source identification model.

Clause 27. An apparatus according to any one of the foregoing Clauses, wherein the instructions that are operable when executed by the at least one processor further cause the apparatus to: identify the human speaker based on one or more portions of frequency-and time-domain linear prediction output of a frequency- and time-domain linear prediction model associated with the acoustic source identification model.

Clause 28. An apparatus according to any one of the foregoing Clauses, wherein the instructions that are operable when executed by the at least one processor further cause the apparatus to: rank the one or more respective acoustic sources based on the priority level indicated in the user audio profile associated with the one or more respective acoustic sources.

Clause 29. An apparatus according to any one of the foregoing Clauses, wherein the instructions that are operable when executed by the at least one processor further cause the apparatus to: determine, based on the user audio profile, that the human speaker is a primary acoustic source of the one or more acoustic sources.

Clause 30. An apparatus according to any one of the foregoing Clauses, wherein the instructions that are operable when executed by the at least one processor further cause the apparatus to: apply a personalized voice lift to the one or more audio signals generated by the primary acoustic source.

Clause 31. An apparatus according to any one of the foregoing Clauses, wherein the instructions that are operable when executed by the at least one processor further cause the apparatus to: augment, based on the personalized voice lift, one or more audio signal attributes associated with the one or more audio signals generated by the primary acoustic source relative to other audio signals generated by one or more different acoustic sources in the acoustic environment.

Clause 32. An apparatus according to any one of the foregoing Clauses, wherein the instructions that are operable when executed by the at least one processor further cause the apparatus to: apply a personalized microphone lobe priority to a first acoustic source of the one or more acoustic sources.

Clause 33. An apparatus according to any one of the foregoing Clauses, wherein the first acoustic source is a primary acoustic source of the one or more acoustic sources.

Clause 34. An apparatus according to any one of the foregoing Clauses, wherein the personalized microphone lobe priority is associated with a respective microphone lobe of the one or more microphone lobes.

Clause 35. An apparatus according to any one of the foregoing Clauses, wherein the personalized microphone lobe priority is associated with a respective microphone lobe that is currently directed toward the first acoustic source as the first acoustic source changes physical locations within the acoustic environment.

Clause 36. An apparatus according to any one of the foregoing Clauses, wherein the personalized microphone lobe priority is associated with a predetermined lobe location associated with the acoustic environment.

Clause 37. An apparatus according to any one of the foregoing Clauses, wherein the personalized microphone lobe priority is associated with a tracking zone of a respective steerable microphone array.

Clause 38. An apparatus according to any one of the foregoing Clauses, wherein the instructions that are operable when executed by the at least one processor further cause the apparatus to: augment, based on the personalized microphone lobe priority, one or more audio signal attributes associated with the one or more audio signals generated by the specific acoustic source relative to other audio signals generated by different acoustic sources of the one or more acoustic sources in the acoustic environment.

Clause 39. An apparatus according to any one of the foregoing Clauses, wherein the instructions that are operable when executed by the at least one processor further cause the apparatus to: augment the other audio signals generated by the different acoustic sources based on the personalized microphone lobe priority associated with the specific acoustic source.

Clause 40. An apparatus according to any one of the foregoing Clauses, wherein the instructions that are operable when executed by the at least one processor further cause the apparatus to: augment the other audio signals generated by the different acoustic sources based on a priority list.

Clause 41. An apparatus according to any one of the foregoing Clauses, wherein the priority list is generated based on a ranking of the one or more respective acoustic sources, and wherein the ranking is based on the priority level indicated in the user audio profile associated with the one or more respective acoustic sources.

Clause 42. An apparatus according to any one of the foregoing Clauses, wherein the instructions that are operable when executed by the at least one processor further cause the apparatus to: output the one or more audio signals to an output device.

Clause 43. A computer-implemented method comprising steps according to any one of the foregoing Clauses.

Clause 44. A non-transitory computer-readable storage medium comprising computer code that, with one or more processors, configure an apparatus to perform operations of any of the foregoing Clauses.

Clause 45. An apparatus comprising at least one processor and a memory storing instructions that are operable, when executed by the at least one processor, to cause the apparatus to: receive audio signals captured by one or more steerable microphone arrays situated within an acoustic environment; identify an acoustic source associated with the one or more audio signals; generate one or more localization objects associated with the acoustic source as the acoustic source changes physical locations within the acoustic environment; and continuously direct, based on the one or more localization objects, one or more microphone lobes associated with the one or more steerable microphone arrays toward the acoustic source.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and a memory storing instructions that are operable, when executed by the at least one processor, to cause the apparatus to:
receive one or more audio signals captured by one or more steerable microphone arrays situated within an acoustic environment;
identify, based on the one or more audio signals and an acoustic source identification model, an acoustic source associated with the one or more audio signals;
generate, based on the one or more audio signals, a localization object associated with the acoustic source within the acoustic environment;
direct, based on the localization object, one or more microphone lobes associated with the one or more steerable microphone arrays toward the acoustic source;
generate, based on one or more subsequent audio signals, an updated localization object associated with the acoustic source; and
direct, based on the updated localization object, the one or more microphone lobes of the one or more steerable microphone arrays toward the acoustic source.

2. The apparatus of claim 1, wherein each steerable microphone array of the one or more steerable microphone arrays is associated with a known location within the acoustic environment.

3. The apparatus of claim 1, wherein the localization object comprises a location of the acoustic source within the acoustic environment.

4. The apparatus of claim 1, wherein the one or more microphone lobes are directed toward the acoustic source based on one or more audio signal attributes associated with the one or more audio signals.

5. The apparatus of claim 4, wherein the one or more audio signal attributes comprise one or more of
acoustic features comprising one or more of an angle of arrival, a gain, a frequency, a pitch, a timbre, an articulation, a volume, or an intensity,
emotive qualities comprising one or more of a valence, an activation, or a dominance, or
speech delivery characteristics comprising one or more of a pause duration, a pace, or a speech rate.

6. The apparatus of claim 1, wherein the one or more microphone lobes are directed toward the acoustic source based on an orientation of the acoustic source relative to a tracking zone associated with a respective steerable microphone array of the one or more steerable microphone arrays.

7. The apparatus of claim 6, wherein the tracking zone is associated with an audio capture coverage area of the respective steerable microphone array.

8. The apparatus of claim 1, wherein a first microphone lobe of a first steerable microphone array is directed toward the acoustic source based on a first plurality of audio signal attributes associated with a first plurality of audio signals.

9. The apparatus of claim 8, wherein the first plurality of audio signals is generated within range of a first tracking zone associated with the first steerable microphone array.

10. The apparatus of claim 1, wherein the one or more microphone lobes are directed toward the acoustic source based on one or more portions of image data associated with the acoustic source, and wherein the one or more portions of image data are captured by an image capturing device situated in the acoustic environment.

11. The apparatus of claim 1, wherein the instructions that are operable when executed by the at least one processor further cause the apparatus to:
determine that the acoustic source is navigating toward a second tracking zone associated with a second steerable microphone array.

12. The apparatus of claim 11, wherein a second microphone lobe of the second steerable microphone array is directed toward the acoustic source based on a second plurality of audio signal attributes associated with a second plurality of audio signals.

13. The apparatus of claim 12, wherein the second plurality of audio signals is generated within range of the second tracking zone associated with the second steerable microphone array.

14. The apparatus of claim 1, wherein the acoustic source identification model is trained in part using one or more portions of labeled audio signal data comprising one or more of human speech signals, audio signals associated with various musical instruments, portions of user audio profile data, or voice feature vectors.

15. The apparatus of claim 1, wherein the instructions that are operable when executed by the at least one processor further cause the apparatus to:
identify that the acoustic source is a first acoustic source of one or more acoustic sources generating respective audio signals within the acoustic environment.

16. The apparatus of claim 15, wherein the instructions that are operable when executed by the at least one processor further cause the apparatus to:
determine that the acoustic source is a human speaker; and
determine a user audio profile associated with the human speaker.

17. The apparatus of claim 16, wherein the instructions that are operable when executed by the at least one processor further cause the apparatus to:
apply, based on the user audio profile, one or more equalization (EQ) preferences to the one or more audio signals generated by the human speaker.

18. The apparatus of claim 17, wherein the user audio profile comprises one or more of a voice feature vector, an EQ preference set, a priority level, a user identifier, portions of user contact data, an organizational identifier, or portions of image data associated with the human speaker.

19. The apparatus of claim 18, wherein the voice feature vector is related to a speaking voice associated with the human speaker.

20. The apparatus of claim 18, wherein the voice feature vector comprises one or more portions of voice feature data comprising one or more of Mel-frequency cepstral coefficients (MFCC), frequencies, pitches, frequency patterns, speech patterns, timbres, or vocal tract resonances.

21-45. (canceled)
